(19) United States
(12) Patent Application Publication
(10) Pub. No.: US 2013/0255850 A1
(43) Pub. Date: Oct. 3, 2013

(54) UNIVERSAL VENEERING OF FRAMEWORKS OF DENTAL RESTORATIONS

(71) Applicants: Norbert Thiel, Bad Sackingen (DE); Enno Bojemüller, Bad Sackingen (DE); Michael Tholey, Bad Sackingen (DE)

(72) Inventors: Norbert Thiel, Bad Sackingen (DE); Enno Bojemüller, Bad Sackingen (DE); Michael Tholey, Bad Sackingen (DE)

(73) Assignee: Vita Zahnfabrik H. Rauter GmbH & Co. KG, Bad Sackingen (DE)

(21) Appl. No.: 13/990,508

(22) PCT Filed: Dec. 9, 2011
(86) PCT No.: PCT/EP2011/072299

§ 371 Date: May 30, 2013

Related U.S. Application Data
(60) Provisional application No. 61/457,021, filed on Dec. 9, 2010.

(30) Foreign Application Priority Data
Dec. 9, 2010 (EP) 10194373.6
Jul. 4, 2011 (EP) 11172577.6

(51) Int. Cl. A61C 13/07

(52) U.S. Cl. CPC A61C 13/0025
USPC 156/60

(57) ABSTRACT

A process for the universal, at least partial, veneering of frameworks made of framework materials of dental restorations having a coefficient of thermal expansion CTE_{framework} by means of using a ceramic-based veneer material having a coefficient of thermal expansion CTEᵥₑₙₑₑᵣ, wherein a veneer is prepared by a shaping process from a blank of the respective veneer material to be complementary to the framework, and permanently attached to the framework by adhesive bonding, wherein the difference (Δ_{CTE}) between the coefficient of thermal expansion of the framework material, CTE_{framework}, and the coefficient of thermal expansion of the veneer material, CTEᵥₑₙₑₑᵣ, is outside the range of 0≦Δ_{CTE}<2×10⁻⁶ K⁻¹.

The present invention relates to a process for the universal, at least partial, veneering of frameworks made of framework materials of dental restorations.

Currently, different veneering ceramics are employed for each dental framework material, i.e., dental technicians and dentists require a huge assortment of different veneering ceramics to be able to veneer all framework materials that may be employed. The selection of the veneering ceramics is respectively dependent on the CTE (coefficient of thermal expansion) of the framework material (p. 35, H. F. Kappert “Vollkeramik—Werkstoffkunde—Zahntechnik—klinische Erfahrung” Quintessenz-Verlag 1996 ISBN 3-87652-088-6). Thus, the coefficient of thermal expansion of the veneer is to be slightly lower than the coefficient of thermal expansion of the framework in order to produce ideal adhesion (p. 200, Chapter 9, Caesar/Ernst “Grundwissen für Zahntechniker”, Volume II “Die Nichtmetalle in der Zahntechnik” Verlag Neuer Merkur GmbH, first edition, 1987). In addition, implant-borne dental restorations are often very rigid, and the veneer can easily chip off.

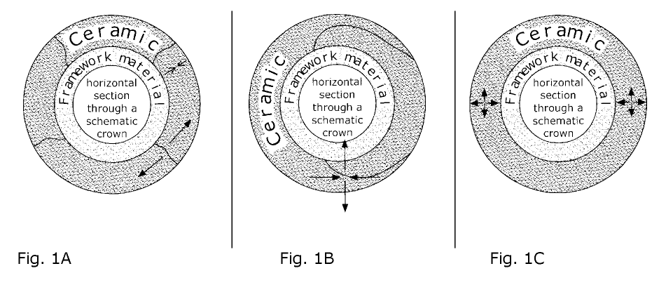

Thus, for example, a veneering ceramic having a coefficient of thermal expansion of from 9 to 10.4×10⁻⁶ K⁻¹ is employed for veneering a framework material having a CTE of 10.5×10⁻⁶ K⁻¹, such as Y-TZP. Any deviation from the difference empirically rated as tolerable may lead to useless results. If the CTE of the framework material is greater than that of the veneering material, the ceramic may chip off during the firing process. In contrast, if the CTE_{framework} is too small as compared to the CTEᵥₑₙₑₑᵣ of the veneering ceramic, a solid bonding between the veneer and framework is not obtained. Therefore, the experts are convinced that it is indispensable to match the CTE values of the veneer and framework. FIGS. 1A to C illustrate these relationships. If the CTE of the framework material is very much lower than the CTE of the veneer ceramic, the tangential tensile stresses increase and cause radially outward running cracks. This can lead to late fracture (FIG. 1A). If the CTE of the framework material is very much higher than the CTE of the veneer ceramic, the tangential compressive stresses increase and cause fractures running almost parallel to the framework. This can lead to chipping (FIG. 1B).

The ideal tangential compressive and radial tensile stress is present if the CTE of the ceramic has been optimally matched to the CTE of the framework material (FIG. 1C).

Marketable veneering ceramics are available from many manufacturers, such as Ivoclar Vivadent, Dentsply and VITA Zahnfabrik. These veneering ceramics are usually applied as a premixed slip material to the frameworks, which are made of different materials, in several firing steps (up to six different firing operations). Each veneering ceramic has its own firing program, so that the user is subject to limitations in the use of the veneering ceramics in view of the different framework materials. The veneering of framework materials is also very time-consuming, since a duration of about 20 to 25 minutes must be calculated per firing operation.

Thus, for veneering a restoration with a framework of metal, which may be made, for example, of either of a precious metal alloy or a CoCr alloy, two opaque firing operations must be performed first to cover the framework and to achieve a similar base for veneering. Thereafter, the veneering ceramic, which must match the framework and is thus different from that employed for frameworks of Y-TZP, is premixed with an appropriate modelling liquid as a slip. Then, the so-called first dentin firing is performed. After the first dentin firing, first corrections are made on the veneer by means of abrasive bodies, followed by cleaning, and then the sliplike veneering ceramic is again applied with a suitable device, for example, a brush, and fired. If necessary, this step is repeated up to four times. Finally, a texture is applied to the ceramic surface using abrasive bodies, and glazing is performed with any necessary colored paints to introduce accents. Only by means of this relatively long and difficult procedure is it possible to prepare a dental prosthesis that meets high aesthetic demands.

In order to avoid the firing into place of the veneering ceramic and the related disadvantages, it is also possible to provide Y-TZP frameworks with veneers prepared by CAD/CAM methods, for example, DVS from 3M ESPE and the so-called Infix technology of Biodentis. In these methods, veneers are bonded with the framework material (Y-TZP) by means of a thermal joining technology. However, thermal stresses may occur in the veneer in this method. In addition, there is the so-called rapid-layer method of VITA Zahnfabrik and Sirona, in which a veneer made of a TriLuxe Forte block is adhesively bonded to a CTE-matched framework of Y-TZP.

JP 2002 153492 A discloses a method for manufacturing a dental prosthesis by using a resin casted metal crown and a ceramic crown which are fixed with an adhesive by a composite resin.

WO-A-2006/120254 relates to a method for production of a tooth replacement piece, whereby the tooth replacement piece is connected to a further tooth replacement piece on an inner surface by means of an adhesive, wherein a gap between an inner surface of the tooth replacement piece and the further tooth replacement piece is provided for the adhesive. The method disclosed therein is characterized in that the inner surface of the tooth replacement piece is constructed taking into account the optical properties of the adhesive. In dental practice also in this case the materials used for making the restauration are selected to have similar coefficients of thermal expansion.

It has now been found, that an adjustment of the materials veneer and framework with regard to their coefficient of thermal expansion is unnecessary. The present invention provides a process for a universal, at least partial, veneering of frameworks made of framework materials of dental restorations having a coefficient of thermal expansion CTE_{framework} by means of using a ceramic-based veneer material having a coefficient of thermal expansion CTEᵥₑₙₑₑᵣ,
wherein a veneer is prepared by a shaping process from a blank of the respective veneer material to be complementary to the framework, and
permanently attached to the framework by adhesive bonding,
wherein the difference (Δ_{CTE}) between the coefficient of thermal expansion of the framework material, CTE_{framework}, and the coefficient of thermal expansion of the veneer material, CTEᵥₑₙₑₑᵣ, is outside the range of 0≦Δ_{CTE}<2×10⁻⁶ K⁻¹.

The process according to the invention enables the preparation of a veneer independent of the CTEs of the respective restoration elements, the veneer on the one hand and the framework on the other, that is prepared by means of CAD/CAM for any kinds of dental framework and monolithic materials. Due to the good CAD/CAM processability of certain materials, the veneer may also be made thinner than is possible with currently existing CAD/CAM materials, and thereby offer a solution for restorations with small space requirements, for example.

For example, when resin-infiltrated ceramics are used for the veneer, a very thin wall thickness, which could not be prepared from ceramic CAD/CAM materials to date, can be prepared. In addition, the elasticity thereof may be useful for cushioning chewing stresses.

The process according to the invention may also be advantageous in implant-borne restorations. Implant superstructures consist predominantly of a metallic base material, because oxide ceramics, in particular, are considered too rigid for this use. Due to the absence of the human senses in the case of an implant, the stresses applied on the jawbone from chewing are increased. This problem is omitted by using metals as a framework material, which can be supported by the use of resin-infiltrated materials as the veneer materials as well as by a bonding joint as a damping element contained in the dental restoration.

In one embodiment of the process according to the invention, the framework material may be selected from the group consisting of metal or alloys of metal, ceramic materials such as leucite-containing or leucite-free feldspar ceramics, lithium disilicate-based ceramics and oxide ceramics and mixtures thereof, glass-infiltrated ceramic materials, resin-infiltrated ceramic materials, ceramic-filled polymer materials, for example, as described in WO-A-02/076907 or as proposed in EP 10175126, and unfilled polymer materials.

In another embodiment of the process according to the invention, the ceramic material may be selected from the group consisting of In-Ceram®, alumina, Y-TZP, spinel, zirconia.

In still another embodiment of the process according to the invention, the veneer material may be selected from the group consisting of feldspar ceramics, leucite-containing or leucite-free feldspar ceramics, lithium disilicate-based ceramics, oxide ceramics, resin-infiltrated ceramics, filled or unfilled polymer materials.

According to the invention, the adhesive bonding for permanently connecting the restoration elements, i.e., the veneer and framework, may be effected, in particular, by means of an inorganic or organic adhesive. Adhesives are different in nature and derive their adhesiveness from different principles, which are familiar to the skilled person. Thus, phosphate cements consist, for example, of an aqueous phosphoric acid solution and metal oxides, predominantly zinc oxide. The curing reaction is based on an acid-base reaction between the phosphoric acid and the basic oxides. They represent a class of very brittle materials.

The polycarboxylate cements contain metal oxides and polyacrylic acid as adhesive components. Mostly, the dry mixture used as a powder is mixed with water to be processed. The curing reaction is effected by a reaction of metal oxides with polyacrylic acid.

Glass ionomer cements have the advantage that they cam release fluoride ions. The setting is also effected by an acid-base reaction. In this case, polyacrylic acid reacts with a calcium fluoroaluminosilicate glass.

In addition to the cement curing described, plastic-reinforced glass ionomer cements include light-curing components. Polymer networks form by light curing in addition to the purely inorganic network. This group of bonding materials includes a whole series of so-called hybrid cements whose physical and clinical properties vary highly depending on the composition of the individual components, but which can be selected and employed by the skilled person depending on the application case and the result to be achieved.

The compomers are already composite materials for the biggest part thereof. They have components such as monomers containing carboxylic acids that react with glass ionomer fillers. They can be applied by the “total etch” technology and form a better adhesion to the hard tooth structure. Due to the monomers' being highly hydrophilic, these materials are very moisture-sensitive and tend to swell.

Bonding composites are wholly constituted on the basis of dental filling composites. They consist of monomers and inorganic filler particles. The curing thereof is based on the light-initiated and/or chemically initiated cross-linking of the polymer chains. Bonding composites are more abrasion-resistant, are resistant in the mouth environment and offer perfect aesthetics by the selection of different colors.

Phosphate cements, polycarboxylate cements and glass-ionomer cements belong to the group of “dental water-based cements” (extract from scientific documentation from Multilink Automix, pages 3 and 4, of the company Ivoclar Vivadent), zinc phosphate cements, for example, Hoffmann's Cement from Hoffmann Dental, glass ionomer cements or plastic-reinforced glass ionomer cements, such as Ketac-Cem from 3M ESPE or Argio from Voco, polycarboxylate cements from Harvard, adhesive composites, such as Variolink and Multilink from Ivoclar Vivadent, and self-adhesive light/dual curing adhesive systems, such as Rely X Unicem from 3M ESPE, and Panavia 21 from Kuraray Dental.

By means of the present invention, it is now possible to employ a single CTE-independent veneer, especially one prepared by CAD/CAM method, especially in the form of a prefabricated veneer, which can be employed for all kinds of different framework materials. This veneer can be bonded to the framework material by means of an adhesive or self-adhesive material commonly used in the dental field, possibly also with zinc phosphate or glass ionomer cements, after it has been ground from a block. The veneer can be additionally individualized with a matching veneer material.

When a resin-infiltrated ceramic is used as the veneer, a very thin wall thickness, which could not be prepared from ceramic CAD/CAM materials to date, can be provided. In addition, the elasticity thereof may be useful for cushioning chewing stresses.

The fact that the framework is also prepared by a shaping process is well compatible with the process according to the invention. Suitable shaping processes include, in particular, CAD/CAM subtractive processes, by which the framework and the veneer can be prepared from a blank and matched to the patient. Also, all additive processes for generating the framework are suitable, for example, laser sintering, such as direct laser sintering as developed by EOS GmbH, Krailing, Germany, or selective laser melting as developed by MTT Technologies GmbH, Borchen, Germany, 3D printing, such as SimPlant CompatAbility of Materialise Dental in Leuven, Belgium, stereolithography, such as the Invisalign method of Align Technology, Santa Clara, U.S.A., and Robocasting as described by the Oklahoma State University, 2007.

By means of the present invention, it is now possible to employ a single kind of veneer using a CAD/CAM method, but which can be employed for all kinds of different framework materials with all the different coefficients of thermal expansion. The veneer is completely independent of the thermal conductivity, solidus or liquidus temperature of the framework materials. It can be employed universally, which has not been possible to date due to CTE dependence according to the experts' understanding. Increased degrees of freedom are now granted to the dentist and dental technician when they realize dental restorations. Due to the fact that the dental technician needs only one kind of veneer, which may additionally be individualized, incorrect firing parameters are almost completely ruled out, since only one particular operation is required for individualization, while previously a separate firing program had to be met strictly for each different veneering ceramic.

Further, the bonding by means of adhesive bonding substantially prevents the build-up of thermal stresses on the veneer, i.e., the veneer and thus the restoration have no inner stresses, in contrast to the veneers prepared by the known methods.

Since the veneer is ground from one block, because of its industrial production, it is virtually free from pores and bubbles, which may form in the manual veneering process. Also, a poor manufacture (e.g., defective casting for framework materials of metal, which may lead to outgassing) has no influence on the quality of the veneer. Since all dental framework materials can be employed as a substrate for the veneer because of the method according to the invention, and the adhesive bonding provides a buffer for the chewing stress and additionally no stresses are present in the veneer, this kind of restoration is more suitable for implant-borne use.

The use of a resin-infiltrated ceramic enables the CAD/CAM production of very thin veneers, which are advantageous when space is restricted. In implant-borne dental prostheses, the elasticity of the resin-infiltrated ceramic provides an additional chewing stress buffer.

Typically, the dental situation of a patient to be provided with a dental restoration is recorded with a scanner, whose data are converted into a restorative dental prosthesis by means of electronic data processing. From the data set, the framework structure of the dental prosthesis is calculated. The same data set also serves for the calculation of the shape of the veneer that is to be adhesively bonded to the framework structure later. From a blank, which is made, for example, of a grindable ceramic material, the framework structure is ground, and the veneer, which is also made of a ceramic material, can then be ground from a ceramic material, for example, compacted by dense sintering or infiltration, and applied to the framework. If a metal framework exists, it may be scanned by a scanner, preferably in situ in the patient's mouth, the corresponding veneer can be calculated and prepared by material subtraction from a blank, for example, by grinding.

Now, the veneer made of a ceramic material need no longer be matched to the CTE of the framework and is permanently attached to the framework, preferably by adhesive bonding.

The present invention is further illustrated by means of the following Examples.

A patient with preparations at tooth 15 and tooth 17, loss of tooth 16 and otherwise complete remaining dentition is treated with the process according to the invention. In all Examples, the patient's case is recorded by means of a scanner unit (in these cases: in Eos BlueCam), and the established data are delivered to the software (in these cases: Sirona Cerec 3.80). The software automatically computes an anatomically complete prosthetic restoration. Subsequently, a framework structure and a veneer are calculated from the data set.

### EXAMPLE 1

The porously presintered framework structure of VITA In-Ceram YZ is ground from a blank in the calculated shape in the milling unit Sirona MC-XL, and then fired at 1530° C. in the sintering furnace VITA ZYrcomat. Thereafter, a veneer is ground from VITABLOCS TriLuxe in the same milling unit Sirona MC-XL to match the sintered framework. After sintering the zirconia framework and glazing the veneer of VITABLOCS TriLuxe, the veneer is adhesively bonded to the framework by means of the self-adhesive composite adhesive RelyX Unicem from 3M ESPE. Subsequently, the bridge restoration is statically loaded in the universal testing machine Zwick 2010, and another bridge restoration is dynamically loaded with 1.2 million cycles in a Dynamess 5KN machine. In both cases, the load on the intermediate element (tooth 16) is applied by a wedge. The results can be seen from the Table.

### EXAMPLE 2

The calculated shape is ground from VITABLOCS TriLuxe in the milling unit Sirona MC-XL. Thereafter, a veneer is ground from VITABLOCS TriLuxe in the same milling unit Sirona MC-XL to match the finished framework. After the glazing of the veneer of VITABLOCS TriLuxe, the veneer is adhesively bonded to the framework by means of the self-adhesive composite adhesive RelyX Unicem, 3M ESPE. Subsequently, the bridge restoration is statically loaded in the universal testing machine Zwick 2010, and another bridge restoration is dynamically loaded with 1.2 million cycles in a Dynamess 5KN machine. In both cases, the load on the intermediate element (tooth 16) is applied by a wedge. The results can be seen from the Table.

### EXAMPLE 3

The calculated shape is ground from VITABLOCS TriLuxe in the milling unit Sirona MC-XL. Thereafter, a veneer (resin-infiltrated ceramic block) is ground in the same milling unit Sirona MC-XL to match the finished framework. After the polishing of the veneer of resin-infiltrated ceramic block, the veneer is adhesively bonded to the framework by means of the self-adhesive composite adhesive RelyX Unicem from 3M ESPE. Subsequently, the bridge restoration is statically loaded in the universal testing machine Zwick Z010, and another bridge restoration is dynamically loaded with 1.2 million cycles in a Dynamess 5KN machine. In both cases, the load on the intermediate element (tooth 16) is applied by a wedge. The results can be seen from the Table.

### EXAMPLE 4

The porously presintered framework structure of VITA In-Ceram alumina is ground in the calculated shape in the milling unit Sirona MC-XL, and then subjected to glass infiltration in a VITA Vacumat 6000. Thereafter, the veneer is ground from VITABLOCS TriLuxe in the same milling unit Sirona MC-XL to match the sintered framework. After sintering the zirconia framework and glazing the veneer of VITABLOCS TriLuxe, the veneer is adhesively bonded to the framework by means of the self-adhesive composite adhesive RelyX Unicem from 3M ESPE. Subsequently, the bridge restoration is statically loaded in the universal testing machine Zwick 2010, and another bridge restoration is dynamically loaded with 1.2 million cycles in a Dynamess 5KN machine. In both cases, the load on the intermediate element (tooth 16) is applied by a wedge. The results can be seen from the Table.

### EXAMPLE 5

The framework structure is ground from VITA CADWaxx in the calculated shape in the milling unit Sirona MC-XL, and then cast in a lost wax process from Remanium Star (Dentaurum, Germany). Thereafter, the veneer is ground from VITABLOCS TriLuxe in the same milling unit Sirona MC-XL to match the finished metal framework. After glazing the veneer of VITABLOCS TriLuxe, the veneer is adhesively bonded to the framework by means of the self-adhesive composite adhesive RelyX Unicem from 3M ESPE. Subsequently, the bridge restoration is statically loaded in the universal testing machine Zwick Z010, and another bridge restoration is dynamically loaded with 1.2 million cycles in a Dynamess 5KN machine. In both cases, the load on the intermediate element (tooth 16) is applied by a wedge. The results can be seen from the Table.

| Example | Material combination | Dynamic load [N] | Static load [N] |
|---|---|---|---|
| 1 | Y-TZP (framework) | supports up to 850 | 2472.0 ± 136.4 |
| | with VITAblocs | | |
| | TriLuxe (veneer) | | |
| 2 | VITAblocs TriLuxe | supports up to 500 | 763.0 ± 50.1 |
| | (framework) with | | |
| | VITAblocs TriLuxe | | |
| | (veneer) | | |
| 3 | TriLuxe (framework) | supports up to 400 | 615.5 ± 3.2 |
| | with resin- | | |
| | infiltrated ceramic | | |
| | (veneer) | | |
| 4 | In-Ceram alumina | supports up to 850 | 1667.2 ± 352.4 |
| | with VITAblocs | | |
| | TriLuxe (veneer) | | |
| 5 | Remanium Star (CoCr | at 1000 [N] no | 2551.7 ± 408.0 |
| | from Dentaurum, | chipping (limit of | |
| | Germany; framework) | machine reached) | |
| | with VITAblocs | | |
| | TriLuxe (veneer) | | |

### COMPARATIVE EXAMPLE 1

The porously presintered framework structure of VITA In-Ceram YZ is ground in the calculated shape in the milling unit Sirona MC-XL, and then sintered at 1530° C. in a VITA ZYrcomat. Thereafter, the veneering ceramic VM9 is applied and fired in a VITA Vacumat 6000. Subsequently, the bridge restoration is statically loaded in the universal testing machine Zwick Z010, and another bridge restoration is dynamically loaded with 1.2 million cycles in a Dynamess 5KN machine. In both cases, the load on the intermediate element (tooth 16) is applied by a wedge. The results can be seen from the Table.

### COMPARATIVE EXAMPLE 2

In this case, the complete prosthesis is directly ground in the complete restoration from VITABLOCS TriLuxe. Subsequently, the bridge restoration is statically loaded in the universal testing machine Zwick Z010, and another bridge restoration is dynamically loaded with 1.2 million cycles in a Dynamess 5KN machine. In both cases, the load on the intermediate element (tooth 16) is applied by a wedge. The results can be seen from the Table.

| Example | Material combination | Dynamic load [N] | Static load [N] |
|---|---|---|---|
| 1 | Y-TZP (framework) | supports up to 700 | 1420.0 ± 357.9 |
| | with VITA VM9 | | |
| | veneer (conventional | | |
| | technology) | | |
| 2 | TriLuxe (alone) | broken at 400 | 619.3 ± 21.6 |
| | | already | |

Unexpectedly, both the dynamic and the static loadability is at least similar to that of the conventional system Y-TZP and VITA VM9, or even better in the cases with the same framework material. Even the framework material VITA In-Ceram alumina, which has a lower bending strength than VITA In-Ceram YZ, with an adhesively bonded veneer reaches the same results as the conventional technology with the veneering ceramic, which was not expected, since the framework materials have significant differences in both their chemical and physical natures. In addition, Example 2 according to the invention reached clearly better values than Comparative Example 2, although only an adhesive intermediate layer is present, but otherwise the same material was used.

1. A process for a universal, at least partial, veneering of frameworks made of framework materials of dental restorations having a coefficient of thermal expansion CTE_{framework} by means of using a ceramic-based veneer material having a coefficient of thermal expansion CTEᵥₑₙₑₑᵣ,
wherein a veneer is prepared by a shaping process from a blank of the respective veneer material to be complementary to the framework, and
permanently attached to the framework by adhesive bonding,
wherein the difference (Δ_{CTE}) between the coefficient of thermal expansion of the framework material, CTE_{framework}, and the coefficient of thermal expansion of the veneer material, CTEᵥₑₙₑₑᵣ, is outside the range of 0≦Δ_{CTE}<2×10⁻⁶ K⁻¹.

2. The process according to claim 1, wherein said framework material is selected from the group consisting of a metallic material, in particular an alloy of metal, a ceramic material, and a polymer material.

3. The process according to claim 2, wherein said metallic material is selected from the group consisting of gold-containing metals as well as cobalt- and/or chromium-based metals and alloys thereof.

4. The process according to claim 2, wherein said ceramic material is selected from the group consisting of glass-infiltrated ceramic materials, oxide ceramics, lithium disilicate-based ceramics, leucite-containing or leucite-free feldspar ceramics, and mixtures thereof, and resin-infiltrated ceramic materials.

5. The process according to claim 2, wherein said polymer material is selected from the group consisting of ceramic-filled and unfilled polymer materials.

6. The process according to claim 1, wherein said veneer material is selected from the group consisting of leucite-containing and leucite-free feldspar ceramics, lithium disilicate-based ceramics, oxide ceramics, resin-infiltrated ceramics, filled or unfilled polymer materials.

7. The process according to claim 1, wherein said adhesive bonding is effected by means of an inorganic or organic adhesive.

8. The process according to claim 5, wherein said inorganic adhesive is a hydraulic adhesive for the bonding of dental restoration elements.

9. The process according to claim 6, wherein said inorganic adhesive is selected from the group consisting of zinc phosphate cements, glass ionomer cements.

10. The process according to claim 7, wherein said organic adhesive is a curable adhesive which, after curing, is suitable for the bonding of dental restoration elements.

11. The process according to claim 8, wherein said organic adhesive is selected from the group consisting of adhesive composites as well as self-adhesive light-curing and/or dual-curing adhesive systems.

12. The process according to claim 1, wherein said framework is prepared by a shaping process.

13. The process according to claim 9, wherein said shaping process includes CAD/CAM subtractive processes by which the framework and the veneer can be prepared from a blank and matched to the patient.
